(19) United States
(12) Patent Application Publication
(10) Pub. No.: US 2017/0357825 A1
(43) Pub. Date: Dec. 14, 2017

(54) INFORMATION PROCESSING TERMINAL WHICH COMMUNICATES CONFIDENTIAL INFORMATION, INFORMATION PROCESSING SYSTEM, COMPUTER READABLE RECORDING MEDIUM HAVING PROGRAM STORED THEREON, AND CONTROL METHOD, AS WELL AS INFORMATION PROCESSING TERMINAL WHICH TRANSMITS CONTROL SIGNAL TO EXTERNAL DEVICE AND COMPUTER READABLE RECODING MEDIUM HAVING PROGRAM STORED THEREON

(71) Applicant: KONICA MINOLTA, INC., Tokyo (JP)

(72) Inventors: Kazusei TAKAHASHI, Nishinomiya-shi (JP); Takehisa YAMAGUCHI, Ikoma-shi (JP); Hirokazu KUBOTA, Otsu-shi (JP)

(73) Assignee: KONICA MINOLTA, INC., Tokyo (JP)

(21) Appl. No.: 15/622,233

(22) Filed: Jun. 14, 2017

(30) Foreign Application Priority Data
Jun. 14, 2016 (JP) 2016-118075

(51) Int. Cl. G06F 21/62; H04W 4/00; H04L 29/06; H04W 12/06; H04L 29/08

(52) U.S. Cl. CPC G06F 21/6245; H04L 63/105; H04W 12/06; H04W 4/008; H04L 67/12

(57) ABSTRACT

An information processing terminal communicates confidential information with a sensor terminal including a first biological sensor which measures biological information of a first type. The information processing terminal includes a reception device which receives a result of measurement by the first biological sensor from the sensor terminal, a second biological sensor which measures the biological information of the first type, and a control device configured to communicate confidential information with the sensor terminal when the result of measurement by the first biological sensor satisfies a predetermined condition for a result of measurement by the second biological sensor.

This application is based on Japanese Patent Application No. 2016-118075 filed with the Japan Patent Office on Jun. 14, 2016, the entire content of which is hereby incorporated by reference.

### BACKGROUND OF THE INVENTION

### Field of the Invention

This disclosure relates to control of an information processing terminal and more particularly to control of an information processing terminal which wirelessly communicates.

### Description of the Related Art

With the tendency toward Internet on Things (IoT) in recent years, use of wireless communication equipment has been promoted. Wireless communication permits easy construction of networks without using physical cables, whereas it is vulnerable to impersonation by a malicious third party.

For a technique to suppress impersonation, for example, Japanese Laid-Open Patent Publication No. 2014-082716 discloses a configuration in which possibility of spoofed connection is lowered without modifying a hardware configuration which increases battery drain. More specifically, according to this technique, when first identification confidential information (a media access control (MAC) address) included in a first pairing request packet and second identification confidential information included in a second pairing request packet satisfy a predetermined condition, a terminal which has wirelessly transmitted the second pairing request packet is registered as a terminal which wirelessly communicates confidential information through a layer higher than a confidential information link layer.

In connection with a technique for securely copying confidential information, for example, Japanese Laid-Open Patent Publication No. 2011-071593 discloses a portable information terminal system which copies a program of a portable information terminal serving as a master into another portable information terminal without using a copy jig device. More specifically, the portable information terminal system establishes wireless connection through a wireless local area network (LAN) to another portable information terminal with which pairing has been specified based on authentication under a public key cryptosystem with the use of an electronic certificate and communicates therewith under symmetric key cryptography by distributing a symmetric encryption key under the public key cryptosystem.

In addition, such a scheme that authentication is performed while buttons provided in two terminals in wireless communication with each other are simultaneously pressed and communication only with a successfully authenticated pair is carried out has also been known as a technique relating to other security communication.

### SUMMARY OF THE INVENTION

The techniques disclosed in Japanese Laid-Open Patent Publications Nos. 2014-082716 and 2011-071593, however, are vulnerable to impersonation by a malicious third party if authentication information such as key information/input information is stolen. Since authentication information is normally configured to be complicated from a point of view of ensured security, it is difficult for a user to memorize the authentication information. Therefore, the user manages the authentication information by using notes or the like. From a point of view of security, however, it is not preferable to take notes of authentication information.

The scheme that authentication is performed while buttons provided in two terminals in wireless communication with each other are simultaneously pressed is also vulnerable to impersonation based on radio waves output from equipment while the buttons are pressed.

The present disclosure was made to solve the problems as described above and an object in one aspect is to provide an information processing terminal which can suppress impersonation while convenience of a user is ensured.

According to one embodiment, an information processing terminal which communicates confidential information with a sensor terminal including a first biological sensor which measures biological information of a first type is provided. The information processing terminal includes a reception device which receives a result of measurement by the first biological sensor from the sensor terminal, a second biological sensor which measures biological information of the first type, and a control device configured to communicate confidential information with the sensor terminal when the result of measurement by the first biological sensor satisfies a predetermined condition for a result of measurement by the second biological sensor.

Preferably, the control device is configured to be able to switch between a first mode in which the confidential information is communicated with the sensor terminal when the result of measurement by the first biological sensor satisfies the predetermined condition and a second mode in which the confidential information is communicated with the sensor terminal without comparison between the result of measurement by the first biological sensor and the result of measurement by the second biological sensor. The control device communicates the confidential information with the sensor terminal in the first mode when a security level of the confidential information to be communicated with the sensor terminal is equal to or higher than a predetermined level.

Further preferably, a storage device which stores the result of measurement by the second biological sensor is further included. The control device encrypts the confidential information with a prescribed result of measurement stored in the storage device and transmits the encrypted confidential information to the sensor terminal in the second mode when the security level of the confidential information to be transmitted to the sensor terminal is lower than the predetermined level.

Preferably, the control device communicates the confidential information with the sensor terminal through short-range wireless communication when the security level of the confidential information to be communicated with the sensor terminal is equal to or higher than the predetermined level.

Further preferably, the control device communicates the confidential information with the sensor terminal through wireless communication higher in bit rate than the short-range wireless communication when the security level of the confidential information to be communicated with the sensor terminal is lower than the predetermined level.

Further preferably, the control device verifies whether or not the confidential information is present in an external device configured to be able to communicate with the sensor terminal when the security level of the confidential information to be transmitted to the sensor terminal is lower than the predetermined level. The control device transmits a control signal having the external device transfer the confidential information to the sensor terminal to any one of the external device and the sensor terminal when presence of the confidential information in the external device is verified.

Further preferably, the information processing terminal is configured to be able to communicate with an external device. The control device is configured to receive the security level of the confidential information from the sensor terminal in receiving the confidential information from the sensor terminal and to transfer the confidential information received from the sensor terminal to the external device when the security level of the confidential information is lower than the predetermined level.

Further preferably, a storage device is further included. The control device is configured to have the storage device store prescribed information when the confidential information received from the sensor terminal is transferred to the external device. The prescribed information includes at least any one of information on connection to the external device, information on an area of storage of the confidential information in the external device, and information used for logging in the external device.

Preferably, the control device includes at least one of a component which transmits information on the security level of the confidential information to be transmitted to the sensor terminal to the sensor terminal and a component which requests from the sensor terminal, information on the security level of the confidential information received from the sensor terminal.

Preferably, an operation acceptance device which accepts input of information is further included. The control device sets the security level of the confidential information to be communicated with the sensor terminal based on information input to the operation acceptance device.

Preferably, an operation acceptance device which accepts input of information is further included. The control device determines the security level of the confidential information to be communicated with the sensor terminal based on any one of information on a storage area where the confidential information is stored, first security information added to the confidential information, and second security information input to the operation acceptance device in communication of the confidential information with the sensor terminal.

Preferably, a storage device which stores the result of measurement by the second biological sensor is further included. The control device includes at least one of a component which encrypts the confidential information to be transmitted to the sensor terminal with a prescribed result of measurement stored in the storage device and a component which decrypts the confidential information received from the sensor terminal based on the prescribed result of measurement.

Further preferably, the prescribed result of measurement includes a most recent result of measurement among the results of measurement by the second biological sensor stored in the storage device.

Preferably, the control device transmits the prescribed result of measurement to the sensor terminal through short-range wireless communication.

According to another aspect, an information processing terminal is an information processing terminal which transmits a control signal to an external device, and the information processing terminal includes a reception device which receives information from a sensor terminal. The sensor terminal includes a first biological sensor which measures biological information of a first type. The reception device is configured to receive a result of measurement by the first biological sensor from the sensor terminal. The information processing terminal further includes a second biological sensor which measures biological information of the first type and a control device which transmits the control signal to the external device when the result of measurement by the first biological sensor satisfies a predetermined condition for a result of measurement by the second biological sensor.

According to yet another aspect, an information processing system including the above-described information processing terminal and a sensor terminal is provided.

According to still another aspect, a non-transitory computer readable recording medium having a program for transmitting a control signal to an external device stored thereon is provided. The program causes the computer to perform receiving a result of measurement of biological information of a first type from a sensor terminal, obtaining the result of measurement of the biological information of the first type by a biological sensor connected to the computer, determining whether or not a result of measurement by the biological sensor satisfies a predetermined condition for the result of measurement received from the sensor terminal, and transmitting the control signal to the external device when it is determined that the predetermined condition is satisfied.

Preferably, the control device is configured to determine that the result of measurement by the first biological sensor satisfies the predetermined condition when a ratio of match between the results of measurement by the first and second biological sensors within a prescribed period is equal to or higher than a prescribed value.

Preferably, an operation acceptance device which accepts input of information is further included. The control device is configured to transmit a request signal requesting measurement of the biological information of the first type by the first biological sensor and transmission of a result of measurement of the biological information to the sensor terminal in response to input of predetermined information to the operation acceptance device.

Further preferably, the control device is configured to transmit again the request signal to the sensor terminal up to a prescribed number of times defined as an upper limit when it is determined that the result of measurement by the first biological sensor transmitted in response to transmission of the request signal does not satisfy the predetermined condition.

Further preferably, the control device is configured to determine whether or not the result of measurement by the first biological sensor satisfies the predetermined condition by calculating a first average value representing an average value of a plurality of results of measurement by the first biological sensor transmitted in response to transmission of the request signal, calculating a second average value representing an average value of a plurality of results of measurement by the second biological sensor corresponding to the plurality of results of measurement by the first biological sensor, and determining whether or not the first average value satisfies a predetermined condition for the second average value.

Further preferably, the control device is configured to correct a result of next measurement by the first biological sensor based on a difference between the first average value and the second average value and to determine whether or not the result of next measurement by the first biological sensor satisfies the predetermined condition when it is determined that the first average value does not satisfy the predetermined condition for the second average value.

Preferably, the control device is configured to further transmit to the sensor terminal, a synchronization signal designating timing to conduct measurement with the first biological sensor. The second biological sensor is configured to measure the biological information of the first type at the timing in accordance with the synchronization signal.

Preferably, the control device is configured to give an error notification when it is determined that the result of measurement by the first biological sensor does not satisfy the predetermined condition.

Preferably, the control device is configured to verify whether or not transmission of the confidential information to the sensor terminal has been successful by comparing the confidential information transmitted to the sensor terminal with at least a part of the confidential information returned from the sensor terminal.

Further preferably, a storage device which stores confidential information to be transmitted to the sensor terminal is further included. The control device is configured to erase from the storage device the confidential information transmitted to the sensor terminal when success of transmission of the confidential information to the sensor terminal has been verified.

According to yet another aspect, with a control method, an information processing terminal including a biological sensor which measures biological information of a first type communicates confidential information with a sensor terminal which measures biological information of the first type. The control method includes receiving a result of measurement of the biological information of the first type from the sensor terminal, measuring biological information of the first type, determining whether or not the result of measurement received from the sensor terminal satisfies a predetermined condition for a result of measurement of the biological information in the measuring biological information, and communicating confidential information with the sensor terminal when it is determined that the predetermined condition is satisfied.

According to yet another aspect, a non-transitory computer readable recording medium having a program stored thereon, the program for causing the computer to perform the control method described above, is provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating overview of an operation of an information processing system according to an embodiment.

FIG. 2 is a block diagram illustrating a hardware configuration of an information processing terminal according to a first embodiment.

FIG. 3 is a diagram representing one example of a specific manner of the information processing terminal according to the first embodiment.

FIG. 4 is a sequence diagram illustrating control for transmission of confidential information to another information processing terminal by the information processing terminal according to the first embodiment.

FIG. 5 is a flowchart illustrating control of communication of confidential information in the information processing terminal according to the first embodiment.

FIG. 6 is a diagram illustrating a table for storing information on communication of the confidential information according to the first embodiment.

FIG. 7 is a diagram illustrating comparison of results of measurement by biological sensors according to the first embodiment.

FIG. 8 is a functional block diagram illustrating a functional configuration of a control device for performing a series of processes for communicating the confidential information.

FIG. 9 is a flowchart illustrating control of communication of the confidential information in the information processing terminal according to the first embodiment.

FIG. 10 is a diagram illustrating an exemplary configuration of an information processing system according to a second embodiment.

FIG. 11 is a block diagram illustrating an exemplary hardware configuration of an information processing terminal according to the second embodiment.

FIG. 12 is a sequence diagram illustrating control for transmission of highly confidential information to another information processing terminal by the information processing terminal according to the second embodiment.

FIG. 13 is a sequence diagram illustrating control for transmission of less confidential information to another information processing terminal by the information processing terminal according to the second embodiment.

FIG. 14 is a diagram illustrating an exemplary configuration of an information processing system according to a third embodiment.

FIG. 15 is a sequence diagram illustrating control for transmission of a control signal to an unmanned aerial vehicle according to the third embodiment.

### DESCRIPTION OF THE PREFERRED EMBODIMENTS

An embodiment of this invention will be described in detail below with reference to the drawings. The same or corresponding elements in the drawings have the same reference characters allotted and description thereof will not be repeated.

### A. Overview

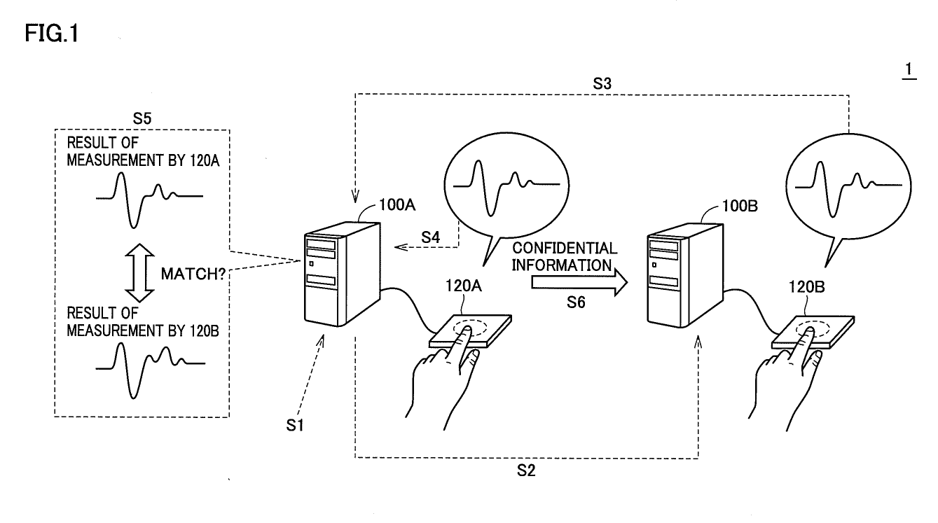

FIG. 1 is a diagram illustrating overview of an operation of an information processing system 1 according to an embodiment. Referring to FIG. 1, information processing system 1 includes an information processing terminal 100A and an information processing terminal 100B. Information processing terminals 100A and 100B include biological sensors 120A and 120B for measuring biological information, respectively.

Control for information processing terminal 100A to communicate confidential information with information processing terminal 100B will be described below.

In step S1, a user inputs to information processing terminal 100A, an instruction for transmitting confidential information to information processing terminal 100B.

In step S2, information processing terminal 100A transmits a signal indicating measurement of biological information with biological sensor 120B to information processing terminal 100B in response to the input of the instruction from the user.

In step S3, information processing terminal 100B measures biological information of the user with biological sensor 120B based on the signal input from information processing terminal 100A and transmits a result of measurement to information processing terminal 100A.

In step S4, information processing terminal 100A measures biological information of the user with biological sensor 120A. A type of the biological information measured with biological sensor 120A is the same as a type of the biological information measured with biological sensor 120B. In steps S3 and 4, biological sensors 120A and 120B measure biological information of the same user.

In step S5, information processing terminal 100A determines whether or not the result of measurement by biological sensor 120B satisfies a predetermined condition for the result of measurement by biological sensor 120A (for example, whether or not results of measurement by both of them match with each other). When information processing terminal 100A determines in step S5 that the result of measurement by biological sensor 120B satisfies the condition, information processing terminal 100A transmits in step S6 confidential information to information processing terminal 100B.

According to the above, in communication of confidential information, the user should only measure biological information of the user himself/herself with the biological sensor mounted on each information processing terminal which communicates. Therefore, the user does not have to memorize complicated authentication information (a password) nor to take notes of the authentication information. Consequently, the information processing system according to the embodiment is higher in security than a conventional system.

The information processing system according to the embodiment performs authentication by using biological information of which copying or obtainment is very difficult for a malicious third party in communication of confidential information. Consequently, the information processing system according to the embodiment can suppress impersonation more than the conventional system. A detailed configuration and control of this information processing system will be described below.

### B. First Embodiment

(b1. Hardware Configuration of Information Processing Terminals 100A and 100B)

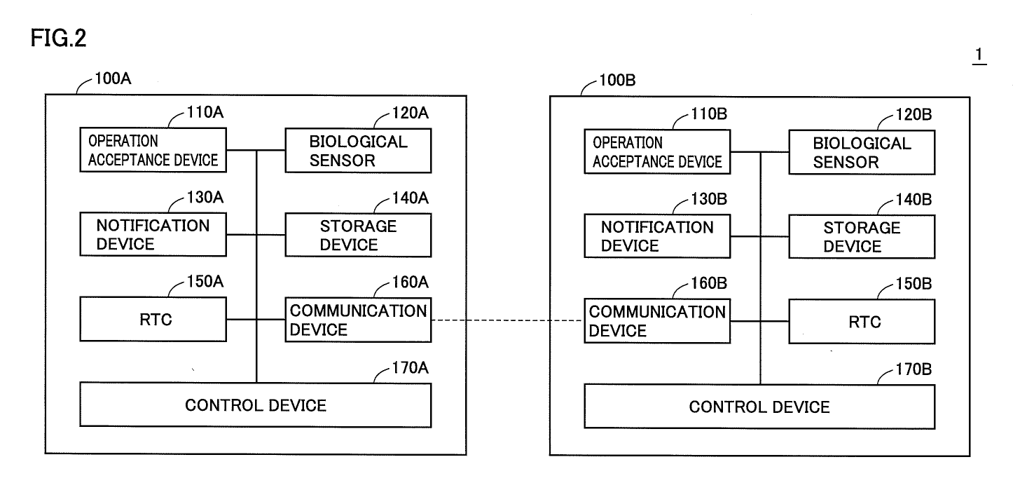

FIG. 2 is a block diagram illustrating a hardware configuration of information processing terminals 100A and 100B according to a first embodiment. Referring to FIG. 2, information processing terminal 100A includes, as main constituent elements, an operation acceptance device 110A, biological sensor 120A, a notification device 130A, a storage device 140A, a real time clock (RTC) 150A, a communication device 160A, and a control device 170A.

Operation acceptance device 110A accepts an operation by a user onto information processing terminal 100A. For example, operation acceptance device 110A is implemented by a mouse, a keyboard, a hardware button, a touch panel, or other input devices.

Biological sensor 120A obtains biological information of a user. By way of example, biological sensor 120A measures pulse waves. The biological information measured by biological sensor 120A is not limited to pulse waves, and in another aspect, a heart rate, a blood pressure, a temperature, a parasympathetic nerve activity, a sympathetic nerve activity, an amount of activity (an acceleration), an electrocardiogram, body motion, percutaneous arterial blood oxygen saturation (SpO2), or a pulse wave transit time may be measured. Preferably, the biological information measured with biological sensor 120A is information which varies over time because it would be more difficult for a malicious third party to obtain such biological information.

Notification device 130A is a component which notifies a user of information and it is implemented by a display by way of example. In another aspect, notification device 130A may be a component which notifies a user of information through vibration by a vibrator or sound from a speaker.

Storage device 140A stores setting of information processing terminal 100A and a result of measurement by biological sensor 120A. RTC 150A is a component which counts time and continues to count time with an embedded battery even when power supply to information processing terminal 100A is stopped.

Communication device 160A is configured to be able to communicate with information processing terminal 100B through wireless communication. By way of example, communication device 160A communicates with information processing terminal 100B under the near field communication (NFC) standard. In another aspect, communication device 160A may communicate under such a wireless communication scheme as an infrared scheme, the Bluetooth® standard, the wireless fidelity (WiFi) standard, and a scheme using electromagnetic induction such as a contactless integrated circuit (IC) card. Preferably, communication device 160A desirably communicates under the short-range wireless communication standard relatively small (for example, 1 meter to several centimeters) in coverage. Impersonation by a malicious third party can thus be suppressed.

Control device 170A is responsible for overall operations of information processing terminal 100A. Control device 170A is implemented, for example, by at least one integrated circuit. The integrated circuit is implemented, for example, as at least one central processing unit (CPU), at least one application specific integrated circuit (ASIC), at least one field programmable gate array (FPGA), or combination thereof.

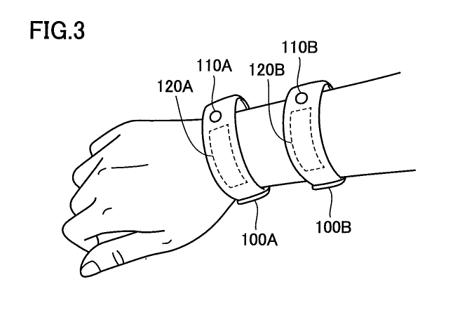

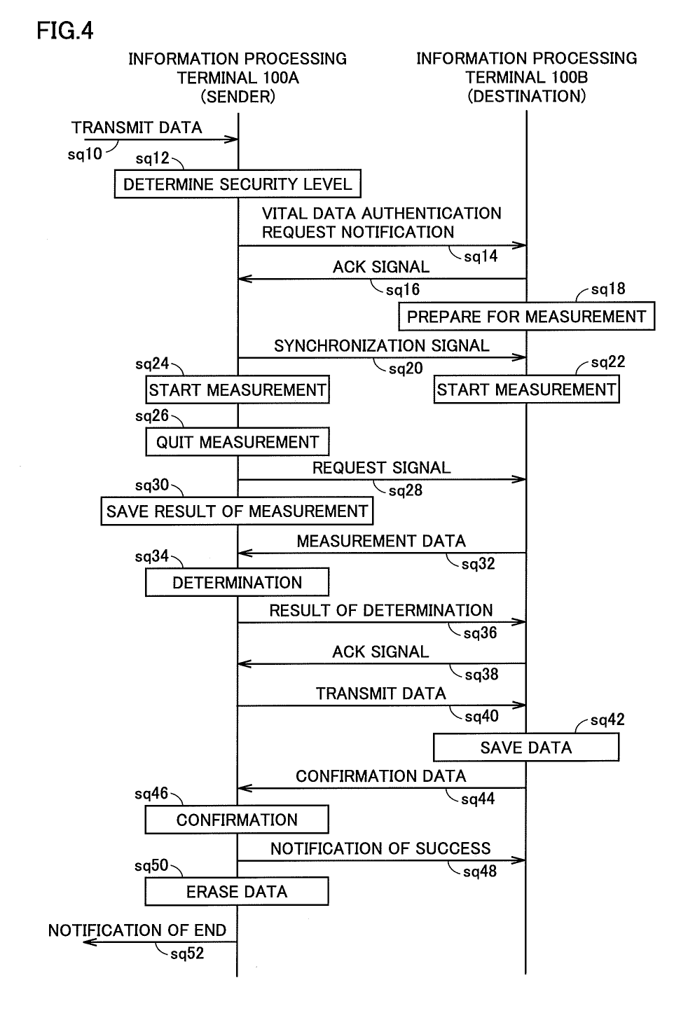

Since information processing terminals 100A and 100B are identical to each other in basic configuration, description of information processing terminal 100B will not be repeated. In another aspect, information processing terminal 100B may be configured differently from information processing terminal 100A and it should only be configured to include at least biological sensor 120B and communication device 160B. In other words, in one aspect, information processing terminal 100B functions as a sensor terminal which measures biological information (pulse waves) of a user with biological sensor 120B and transmits a result of measurement to information processing terminal 100A. Control for information processing terminal 100A to communicate confidential information with information processing terminal 100B will be described below with reference to FIGS. 3 and 4.

(b2. Control for Communicating Confidential Information)

FIG. 3 is a diagram representing one example of a specific manner of information processing terminals 100A and 100B according to the first embodiment. As shown in FIG. 3, information processing terminals 100A and 100B are wearable terminals of a wrist band type configured to be attachable to a user. In another aspect, information processing terminals 100A and 100B may each be a mobile computer, a tablet computer, a mobile device (for example, a smartphone or a PDA), a desktop computer, or any other devices having appropriate processing capability, communication capability, and a memory.

In FIG. 3, operation acceptance devices 110A and 110B are implemented by at least one hardware button. Biological sensors 120A and 120B measure pulse waves with a light reflective sensor arranged on an inner circumferential surface of a wrist band type terminal by way of example.

FIG. 4 is a sequence diagram illustrating control for transmission by information processing terminal 100A of confidential information to 100B according to the first embodiment. In FIG. 4, a user transmits confidential information stored in storage device 140A of information processing terminal 100A to information processing terminal 100B. An exemplary condition may be such that a state of charge of a battery (not shown) which drives information processing terminal 100A is low and a result of measurement in information processing terminal 100A is desirably taken over by another information processing terminal 100B in using information processing terminal 100B. Another exemplary condition may be such that information processing terminal 100B is a successor model of information processing terminal 100A and a result of measurement in information processing terminal 100A is desirably transferred thereto. Other examples of information stored in storage device 140A include such information as password data, a social security and tax number (my number), an employee number, and information on a server which one is authorized to access.

In sequence sq10, a user inputs to operation acceptance device 110A of information processing terminal 100A, an operation defined in advance for transmitting information stored in storage device 140A to information processing terminal 100B.

In sequence sq12, information processing terminal 100A determines whether or not a security level of confidential information designated by the user is equal to or higher than a predetermined level. Details of this processing will be described later. In the example shown in FIG. 4, information processing terminal 100A determines the security level of the confidential information designated by the user as the predetermined level or higher.

In sequence sq14, information processing terminal 100A transmits a vital data authentication request notification to information processing terminal 100B.

In sequence sq16, information processing terminal 100B returns an acknowledgement (ACK) signal notifying that the vital data authentication request notification has been received to information processing terminal 100A.

In sequence sq18, information processing terminal 100B starts preparation for measurement of biological information (pulse waves) by biological sensor 120B.

In sequence sq20, information processing terminal 100A transmits a synchronization signal to information processing terminal 100B in response to reception of the ACK signal from information processing terminal 100B. The synchronization signal synchronizes timing of measurement of biological information (pulse waves) by biological sensors 120A and 120B. By way of example, information processing terminal 100A generates a synchronization signal including time to start measurement, an interval between measurements, and the number of times of measurement by referring to time counted by RTC 150A. In another aspect, information processing terminal 100A may be configured to transmit a synchronization signal including the current time counted by RTC 150A in order to synchronize the current time between RTC 150A and RTC 150B. The interval between measurements and the number of times of measurement included in the synchronization signal are defined in a table Ta1 which will be described later.

In sequence sq22, information processing terminal 100B starts measurement of pulse waves of the user in response to the synchronization signal input from information processing terminal 100A. In sequence sq24, information processing terminal 100A also starts measurement of pulse waves of the user in response to the synchronization signal transmitted to information processing terminal 100B.

In sequence sq26, information processing terminal 100A quits measurement of pulse waves. In sequence sq28, information processing terminal 100A transmits a request signal requesting transmission of a result of measurement by biological sensor 120B to information processing terminal 100B. In sequence sq30, information processing terminal 100A stores (saves) a result of measurement by biological sensor 120A in storage device 140A.

In sequence sq32, information processing terminal 100B transmits the result of measurement by biological sensor 120B to information processing terminal 100A in response to an input of the request signal from information processing terminal 100A.

In sequence sq34, information processing terminal 100A determines whether or not the result of measurement by biological sensor 120A satisfies a predetermined condition for the result of measurement by biological sensor 120B. Details of this determination method will be described later.

In sequence sq36, information processing terminal 100A transmits a result of determination in sequence sq34 that the predetermined condition has been satisfied to information processing terminal 100B.

In sequence sq38, information processing terminal 100B returns the ACK signal notifying that the result of determination has been received to information processing terminal 100A and starts preparation for reception of data from information processing terminal 100A.

In sequence sq40, information processing terminal 100A transmits the confidential information stored in storage device 140A through communication device 160A to information processing terminal 100B in response to reception of the ACK signal from information processing terminal 100B. In another aspect, information processing terminals 100A and 100B may be configured to include another communication interface higher in bit rate than communication devices 160A and 160B separately from communication devices 160A and 160B. In such a configuration, information processing terminal 100A may be configured to use another communication interface for transmission of the confidential information in sequence sq40. Examples of other communication interfaces include the Bluetooth® standard. According to such a configuration, information processing terminals 100A and 100B can efficiently transmit and receive information in accordance with a communication scheme small in coverage such as the NFC standard in order to prevent impersonation until mutual authentication is achieved, and in accordance with a communication scheme higher in bit rate after authentication.

In sequence sq42, information processing terminal 100B saves the confidential information received from information processing terminal 100A in storage device 140B. In sequence sq44, information processing terminal 100B returns at least a part of the information received from information processing terminal 100A to information processing terminal 100A as confirmation data. In another aspect, information processing terminal 100B may be configured to return a cyclic redundancy check (CRC) signal on information received from information processing terminal 100A to information processing terminal 100A.

In sequence sq46, information processing terminal 100A verifies whether or not the confirmation data returned from information processing terminal 100B and the information transmitted to information processing terminal 100B match with each other. In sequence sq48, when information processing terminal 100A verifies match between the confirmation data returned from information processing terminal 100B and the information transmitted to information processing terminal 100B, it transmits a notification of success which notifies information processing terminal 100B of success of backup to information processing terminal 100B.

In sequence sq50, information processing terminal 100A erases (formats) the confidential information stored in storage device 140A, which has been transmitted to information processing terminal 100B, in response to success of verification. Thus, information processing system 1 can erase information which is stored in information processing terminal 100A and may no longer be used by the user so that security can be ensured.

In sequence sq52, information processing terminal 100A shows on notification device 130A that a series of data transfer processes including erasure of information stored in storage device 140A has ended.

The series of sequences does not necessarily have to be performed in the order shown in FIG. 4. For example, sequence sq16 and sequence sq18 may be interchanged. In another aspect, confidential information stored in information processing terminal 100A may desirably be backed up (copied) in information processing terminal 100B. In such a case, information processing terminal 100A may be configured not to perform sequence sq50. Processing in each of information processing terminals 100A and 100B in the series of authentication processes will now be described.

(b3. Processing in Information Processing Terminal 100A)

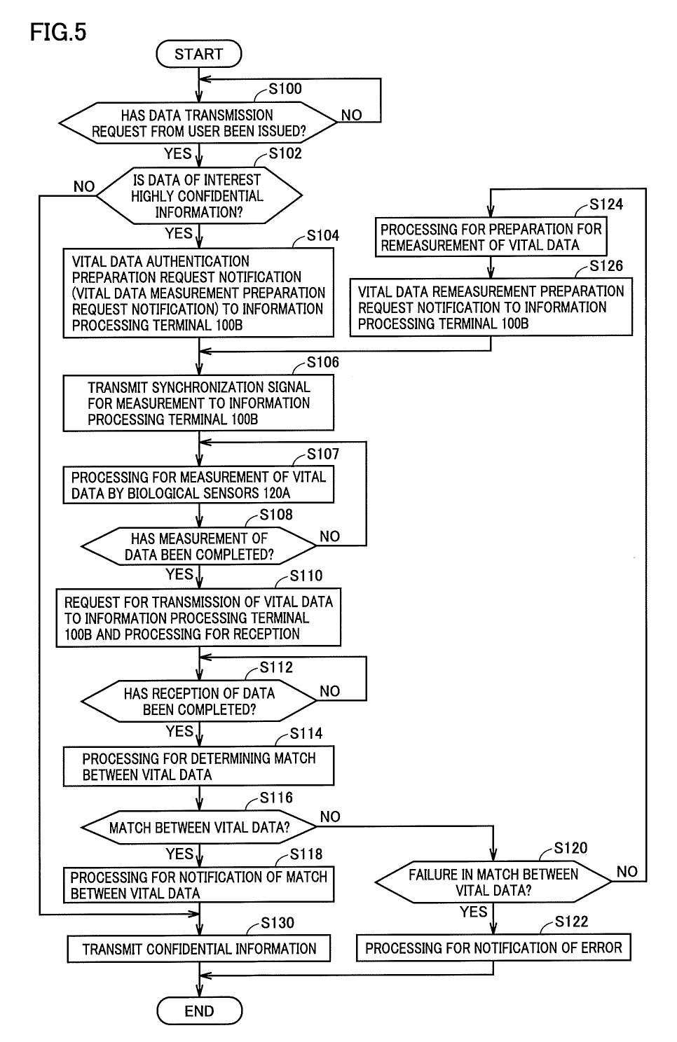

FIG. 5 is a flowchart illustrating control of communication of confidential information in information processing terminal 100A according to the first embodiment. Processing shown in FIG. 5 is performed by execution of a control program stored in storage device 140A by control device 170A. In another aspect, processing may be performed in part or in its entirety by a circuit element or other hardware.

In step S100, control device 170A determines whether or not a data transmission request event has occurred. More specifically, control device 170A makes determination based on contents input to operation acceptance device 110A.

When control device 170A determines that the data transmission request event from a user has occurred (YES in step S100), the process proceeds to step S102. Otherwise (NO in step S100), the process returns to step S100 and control device 170A waits for occurrence of a data transmission request event.

In step S102, control device 170A determines whether or not data of interest in the data transmission request event requires comparison and determination based on biological information (vital data) (hereinafter also referred to as “highly confidential information”). More specifically, control device 170A makes such determination based on a security level of the data of interest.

The highly confidential information is information of which leakage to the outside is serious, and examples thereof include password data, a social security and tax number (my number), an employee number, information on a server which one is authorized to access, and biological information (a result of measurement by biological sensor 120A).

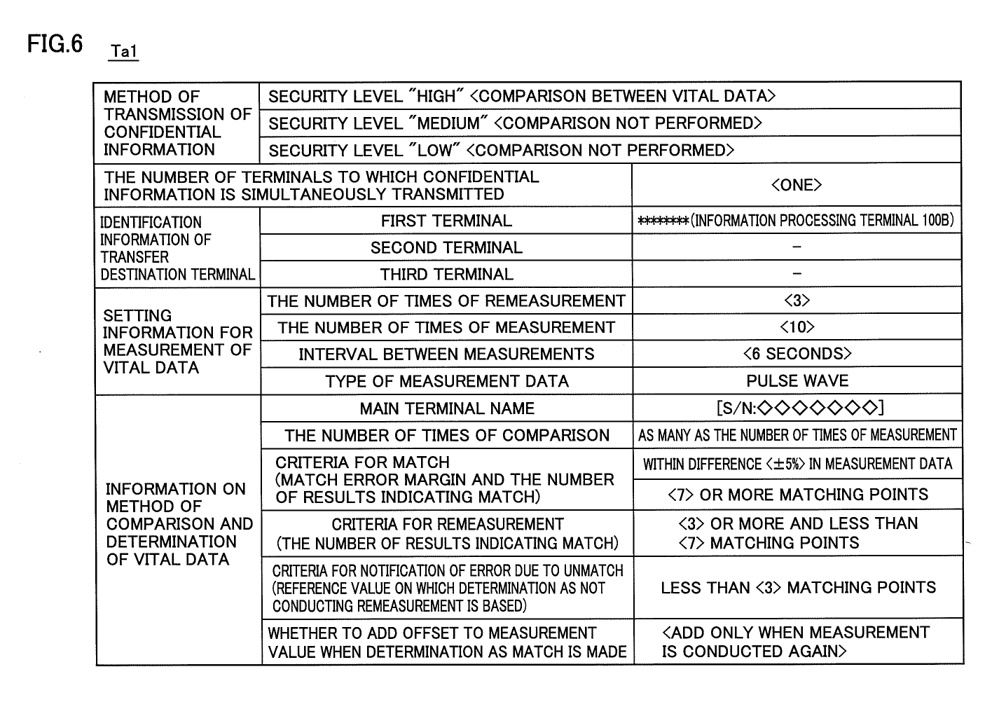

Control device 170A determines a security level of data of interest based on a storage area where the data of interest is stored (whether or not data is saved in a specific folder) or security information added to the data of interest. A user can set a security level of confidential information stored in storage device 140A and including the data of interest by operating operation acceptance device 110A. After control device 170A determines the security level of data of interest, it determines whether or not the data of interest is highly confidential information requiring comparison and determination based on biological information by referring to table Ta1 shown in FIG. 6.

FIG. 6 is a diagram illustrating table Ta1 for storing information on communication of the confidential information according to the first embodiment. Table Ta1 includes a method of transmitting confidential information, the number of terminals to which confidential information is simultaneously transmitted, identification information of a terminal to which confidential information is transmitted, setting information for measurement of biological information (vital data), and information on a method of comparison and determination of biological information, and the table is stored in storage device 140A.

The method of transmitting confidential information is set for each security level. In the example shown in FIG. 6, control device 170A is set to transmit confidential information “high” in security level after comparison based on biological information and to transmit confidential information “medium” and “low” in security level without comparison based on biological information. Confidential information not requiring comparison and determination based on biological information will hereinafter also be referred to as “less confidential information.”

In another aspect, information shown in FIG. 6 may be present as an independent table. In the example shown in FIG. 6, a value in <> is configured to be variable through an operation of operation acceptance device 110A by a user/a manager. In one aspect, information processing terminal 100A has a determination method according to conventional secure simple pairing (SSP) other than the determination method based on comparison of biological information as a method of transmitting confidential information, and it may be configured to allow a user to select any determination method.

In another aspect, control device 170A may be configured to ask a user about a security level of data of interest or whether or not comparison and determination based on biological information is required through notification device 130A in response to occurrence of a transmission request event. According to such a configuration, a user responds to contents of an inquiry shown on notification device 130A through operation acceptance device 110A.

When control device 170A determines that the data of interest is highly confidential information (YES in step S102), the process proceeds to step S104. Otherwise (NO in step S102), control device 170A transmits the data of interest to information processing terminal 100B without making determination based on comparison of the biological information (step S130).

In step S104, control device 170A transmits a vital data authentication request notification to information processing terminal 100B. The vital data authentication request notification substantially functions as a signal requesting from information processing terminal 100B, measurement of the biological information (pulse waves) of a user with biological sensor 120B.

In another aspect, control device 170A may be configured to transmit information on a security level of the data of interest to information processing terminal 100B instead of the vital data authentication request notification. In such a case, information processing terminal 100B also has information at least on a method of transmitting confidential information in table Ta1. Information processing terminal 100B determines whether or not biological information should be measured with biological sensor 120B based on the received information on the security level, and when it determines that measurement is required, it prepares for measurement.

In step S106, control device 170A generates a synchronization signal by referring to table Ta1 in response to reception of the ACK signal from information processing terminal 100B and transmits the synchronization signal to information processing terminal 100B. In the example shown in FIG. 6, control device 170A transmits a synchronization signal including time to start measurement and an indication that measurement be conducted at a 6-second interval 10 times in total to information processing terminal 100B.

In step S107, control device 170A has biological sensor 120A measure biological information (pulse waves) under a condition the same as defined in the synchronization signal transmitted to information processing terminal 100B.

In step S108, control device 170A determines whether or not measurement of the biological information with biological sensor 120A has ended. In the example shown in FIG. 6, control device 170A determines that measurement of the biological information has ended at the time point when biological sensor 120A obtains ten results of measurement in total.

When control device 170A determines that measurement of the biological information with biological sensor 120A has ended (YES in step S108), the process proceeds to step S110. Otherwise (NO in step S108), the process returns to step S107.

In step S110, control device 170A transmits a request signal requesting a result of measurement by biological sensor 120B to information processing terminal 100B. Thereafter, information processing terminal 100A receives the result of measurement by biological sensor 120B transmitted from information processing terminal 100B.

In step S112, control device 170A determines whether or not reception of the result of measurement by biological sensor 120B from information processing terminal 100B has been completed. When control device 170A determines that reception has been completed (YES in step S112), the process proceeds to step S114. Otherwise (NO in step S112), control device 170A stands by until reception of the result of measurement by biological sensor 120B is completed.

In another aspect, control device 170A may be configured such that when it cannot receive the result of measurement from information processing terminal 100B after lapse of a prescribed time period since transmission of the request signal requesting a result of measurement by biological sensor 120B, it transmits a request signal again or gives an error notification to notification device 130A.

In step S114, control device 170A determines whether or not the result of measurement by biological sensor 120B received from information processing terminal 100B satisfies a predetermined condition for the result of measurement by biological sensor 120A. More specifically, control device 170A determines whether or not corresponding results of measurement by biological sensors 120A and 120B match with each other under criteria shown in table Ta1 shown in FIG. 6.

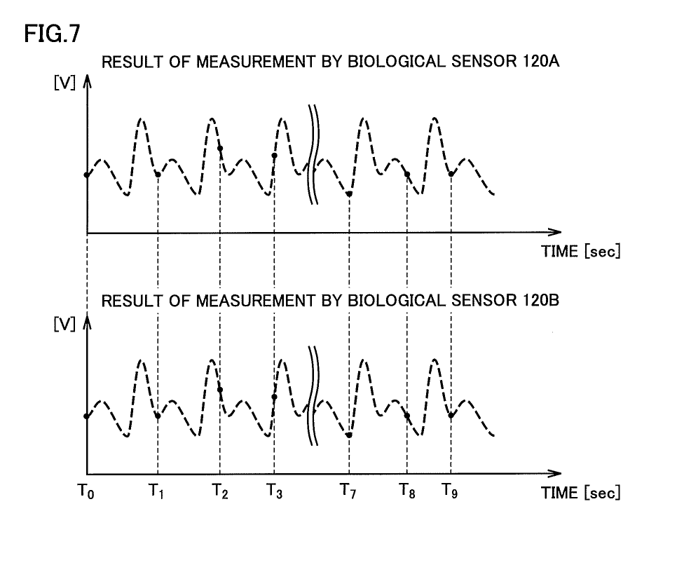

FIG. 7 is a diagram illustrating comparison of results of measurement by biological sensors 120A and 120B according to the first embodiment. In the example above, biological sensors 120A and 120B measure pulse waves of a user. In the example in FIG. 7, outputs from biological sensors 120A and 120B indicate voltages representing a ratio of reflected light to incident light.

Biological sensors 120A and 120B start measurement of pulse waves from time T0 in response to a synchronization signal and measure pulse waves at 10 time points in total of time points T1, T2, T3, . . . , and T9 every six seconds.

Control device 170A compares each result of measurement by biological sensor 120A with each corresponding result of measurement by biological sensor 120B in a determination example shown in FIG. 6. When a difference between a measurement value from biological sensor 120A and a corresponding measurement value from biological sensor 120B is within 5%, control device 170A determines that these results of measurement match with each other. For example, when a difference between the measurement value from biological sensor 120A and the measurement value from 120B at time T1 is 3% of the measurement value from biological sensor 120A, control device 170A determines that the corresponding results of measurement at time T1 match with each other.

Referring again to FIG. 5, in step S116, control device 170A determines whether or not results of measurement by biological sensors 120A and 120B match with each other. In the example shown in FIG. 6, when there are seven or more results of measurement indicating match among ten corresponding results of measurement from biological sensors 120A and 120B, control device 170A determines that the result of measurement by biological sensor 120B satisfies a predetermined condition for the result of measurement by biological sensor 120A, that is, results of measurement by biological sensors 120A and 120B match with each other.

When control device 170A determines that the results of measurement by biological sensors 120A and 120B match with each other (YES in step S116), the process proceeds to step S118. Otherwise (NO in step S116), the process proceeds to step S120.

In step S118, control device 170A transmits a vital data match notification indicating match between the results of measurement by biological sensors 120A and 120B to information processing terminal 100B. Thereafter, in step S130, control device 170A allows transmission of confidential information to information processing terminal 100B.

In step S120, control device 170A determines whether or not the results of measurement by biological sensors 120A and 120B fail to match with each other. In the example shown in FIG. 6, control device 170A determines that the results of measurement by biological sensors 120A and 120B fail to match with each other when there are less than three results of measurement indicating match among ten corresponding results of measurement by biological sensors 120A and 120B.

When control device 170A determines that the results of measurement by biological sensors 120A and 120B fail to match with each other (YES in step S120), the process proceeds to step S122. Otherwise (NO in step S120), the process proceeds to step S124.

In step S122, control device 170A notifies notification device 130A of an error indicating unmatch between the results of measurement by biological sensors 120A and 120B.

In step S124, processing for remeasuring biological information is performed. In step S126, control device 170A transmits a signal requesting measurement of biological information of the user with biological sensor 120B to information processing terminal 100B. In the example shown in FIG. 6, when there are three or more and less than seven results of measurement indicating match among ten corresponding results of measurement by biological sensors 120A and 120B, control device 170A newly measures biological information and determines again match/unmatch of new biological information.

Though control device 170A performs processing such that the process proceeds from step S120 to step S124 in the example above, limitation thereto is not intended. In another aspect, as shown in FIG. 6, control device 170A may set the upper limit of the number of times of remeasurement of biological information. In such a case, control device 170A may be configured to count the number of times of remeasurement before transition from step S120 to step S124 and to perform processing in step S122 when it is determined that the number of counts exceeds a prescribed number of times (three times in the example in FIG. 6).

In another aspect, control device 170A may be configured otherwise, rather than being configured to determine whether or not a ratio of match between results of measurement by biological sensors 120A and 120B within a prescribed period is equal to or higher than a prescribed value as above in determination of match/unmatch between the results of measurement. The configuration may be, for example, such that whether or not a similarity calculated from amplitude, a period, or timing of an inflection point between the results of measurement by biological sensors 120A and 120B is equal to or higher than a prescribed value is determined.

Though information processing terminal 100A which transmits confidential information is configured to determine match/unmatch of biological information in the example above, limitation thereto is not intended. In another aspect, information processing terminal 100B which receives confidential information may be configured to determine match/unmatch of biological information and to transmit a result of determination to information processing terminal 100A. According to such a configuration, information processing terminal 100A may be configured to transmit confidential information to information processing terminal 100B upon receiving a result of determination indicating match of biological information.

Correction of data for determining match/unmatch between results of measurement by biological sensors 120A and 120B will now be described.

Results of measurement by biological sensors 120A and 120B may be varied depending on proximity between a sensor and a user. Therefore, in one aspect, control device 170A determines match/unmatch by comparing an average value of results of measurement by biological sensor 120A (hereinafter also referred to as a “first average value”) with an average value of results of measurement by biological sensor 120B (hereinafter also referred to as a “second average value”) when results of measurement do not match with each other (NO in step S116).

For example, when match/unmatch between results of measurement is determined for a second time, control device 170A determines whether or not an average value of results of corresponding first and second measurements by biological sensor 120A matches with an average value of results of corresponding first and second measurements by biological sensor 120B. The criteria are the same as in determination for the first time.

According to the above, even when results of measurement are varied due to some factor, control device 170A can determine match/unmatch between average values with variation being suppressed each time of remeasurement.

In another aspect, control device 170A may be configured to perform offset correction based on a difference between the first average value and the second average value when results of measurement do not match with each other (NO in step S116). For example, when match/unmatch between results of measurement is determined for a third time, control device 170A calculates the first average value and the second average value based on results of first to third measurements and calculates a difference value obtained by subtracting the first average value from the second average value. Then, control device 170A performs correction for adding the difference value to the result of third measurement by biological sensor 120A. Control device 170A determines match/unmatch by comparing the corrected result of measurement by biological sensor 120A with the result of third measurement by biological sensor 120B.

According to the above, control device 170A can determine match/unmatch between results of measurement by biological sensors 120A and 120B with a manufacturing error and a measurement error resulting from proximity between a sensor and a user being suppressed.

A result of measurement of biological information may be different depending on a measurement site. For example, a blood pressure is measured as being higher than a true value when a measurement site is located at a position lower than the heart. Therefore, in yet another aspect, control device 170A may be configured such that when results of measurement fail to match with each other (YES in step S120), the control device has notification device 130A show an instruction to interchange positions of attachment of information processing terminals 100A and 100B. In this configuration as well, control device 170A uses average values of a result of measurement before interchanging the positions of measurement and a result of measurement after interchange in determination again of match/unmatch between results of measurement. In other words, control device 170A makes determination by using average values of results of measurement before and after an instruction to interchange positions of attachment of information processing terminals 100A and 100B is shown on notification device 130A.

According to the above, control device 170A can determine match/unmatch based on average values of results of measurement, with influence by a measurement site being suppressed.

(b4. Functional Configuration of Control Device 170A)

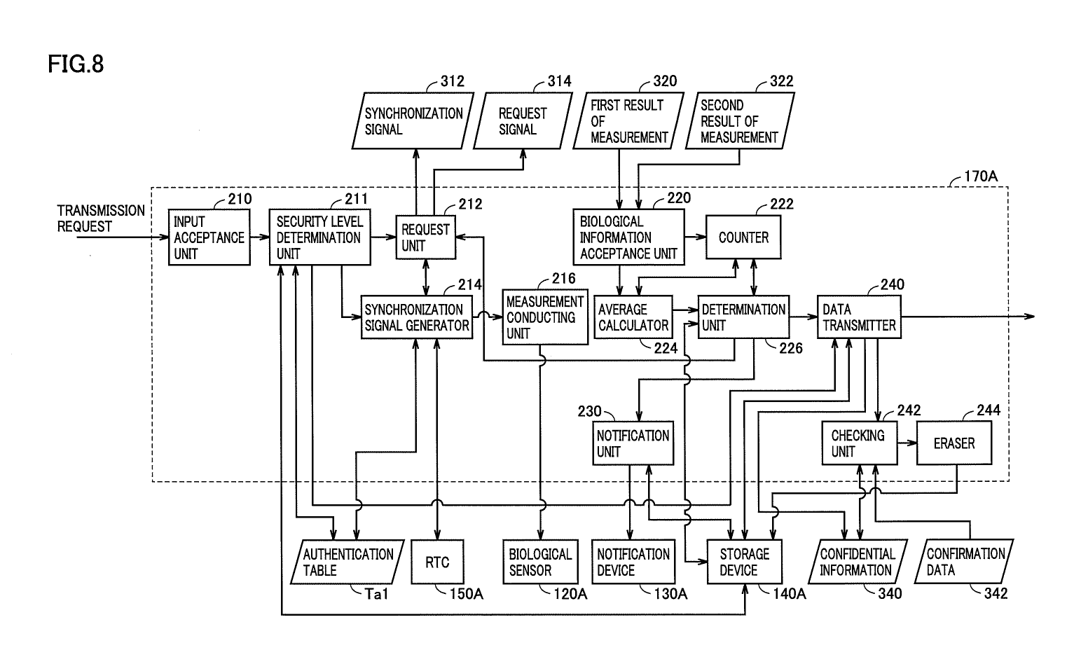

FIG. 8 is a functional block diagram illustrating a functional configuration of control device 170A for performing a series of processes for communicating confidential information. Referring to FIG. 8, control device 170A includes, as main functional components relating to processing for communicating confidential information, an input acceptance unit 210, a security level determination unit 211, a request unit 212, a synchronization signal generator 214, a measurement conducting unit 216, a biological information acceptance unit 220, a counter 222, an average calculator 224, a determination unit 226, a notification unit 230, a data transmitter 240, a checking unit 242, and an eraser 244.

Input acceptance unit 210 accepts a data transmission request from a user through operation acceptance device 110A. Input acceptance unit 210 transmits a signal giving a notification of occurrence of a data transmission request event to security level determination unit 211.

Security level determination unit 211 accesses storage device 140A and determines a security level of data of interest. Then, security level determination unit 211 verifies whether or not the determined security level requires comparison and determination of biological information by referring to table Ta1.

When security level determination unit 211 determines that the data of interest is less confidential information, it transmits a signal notifying data transmitter 240 of that determination. Data transmitter 240 accesses storage device 140A and transmits data of interest to information processing terminal 100B in response to reception of the signal from security level determination unit 211.

When security level determination unit 211 determines that the data of interest is highly confidential information, it transmits a signal notifying request unit 212 and synchronization signal generator 214 of that determination.

Synchronization signal generator 214 generates a synchronization signal based on time counted by RTC 150A and the number of times of measurement and a measurement interval stored in table Ta1 and outputs the synchronization signal to request unit 212 and measurement conducting unit 216.

Request unit 212 transmits a synchronization signal 312 input from synchronization signal generator 214 and a request signal 314 requesting a result of measurement by biological sensor 120B at the timing in accordance with synchronization signal 312 to information processing terminal 100B at appropriate timing.

Measurement conducting unit 216 has biological sensor 120A measure biological information based on synchronization signal 312 input from synchronization signal generator 214.

Biological information acceptance unit 220 accepts inputs of a result of measurement by biological sensor 120A (hereinafter also referred to as a “first result of measurement”) and a result of measurement by biological sensor 120B (hereinafter also referred to as a “second result of measurement”) and outputs such information to average calculator 224. Biological information acceptance unit 220 transmits a signal to counter 222 each time it accepts an input of the first result of measurement or the second result of measurement in a series of data transmission processes.

Counter 222 counts up a value stored in a count up circuit each time it receives an input of a signal from biological information acceptance unit 220 in the series of data transmission processes.

Average calculator 224 calculates a first average value representing an average value of first results of measurement and a second average value representing an average value of second results of measurement. More specifically, average calculator 224 recognizes how many times each biological sensor conducted measurement of biological information in the series of data transmission processes by referring to counter 222. Average calculator 224 calculates the first and second average values by dividing accumulated values of the first and second results of measurement in the series of data transmission processes by the number of times. Average calculator 224 outputs the calculated first and second average values to determination unit 226.

Determination unit 226 determines whether or not the first average value and the second average value match with each other based on criteria stored in table Ta1 by referring to storage device 140A. When determination unit 226 determines that the first average value and the second average value match with each other, it outputs that determination to counter 222, notification unit 230, and data transmitter 240. Counter 222 initializes a value stored in the count up circuit in response to an input from determination unit 226.

Data transmitter 240 transmits confidential information 340 stored in storage device 140A to information processing terminal 100B in response to an input from determination unit 226. Checking unit 242 receives input of confirmation data 342 from information processing terminal 100B. Checking unit 242 verifies whether or not transmission of confidential information 340 to information processing terminal 100B has been successful based on confirmation data 342 and confidential information 340 transmitted to information processing terminal 100B. Checking unit 242 outputs to eraser 244, a signal giving a notification of success of transmission of confidential information 340 to information processing terminal 100B. Eraser 244 erases confidential information 340 stored in storage device 140A in response to an input from checking unit 242.

When determination unit 226 determines that the first average value and the second average value do not match with each other, it outputs that determination to notification unit 230. Notification unit 230 receives an input of a signal indicating that the first average value and the second average value do not match with each other from determination unit 226, reads an error image stored in storage device 140A, and has notification device 130A show the image. A user can thus recognize that information processing terminal 100A has failed in authentication of a terminal which is a transmission destination of confidential information.

When determination unit 226 determines that the first average value and the second average value neither match nor unmatch with each other, it determines whether or not measurement of biological information by the biological sensors has been conducted a predetermined number of times (for example, three times) or less in a series of authentication processes by referring to counter 222.

When determination unit 226 determines that measurement of biological information by the biological sensors has been conducted a predetermined number of times or less, it outputs that determination to request unit 212. Request unit 212 requests generation of a synchronization signal from synchronization signal generator 214 in response to the input from determination unit 226. Request unit 212 transmits synchronization signal 312 input from synchronization signal generator 214 and request signal 314 to information processing terminal 100B at appropriate timing.

When determination unit 226 determines that the number of times of measurement of biological information by the biological sensors exceeds the predetermined number of times, it outputs that determination to notification unit 230. Notification unit 230 reads an error image stored in storage device 140A and has notification device 130A show the image in response to the input from determination unit 226. Processing in information processing terminal 100B in the series of authentication processes will now be described.

(b5. Processing in Information Processing Terminal 100B)

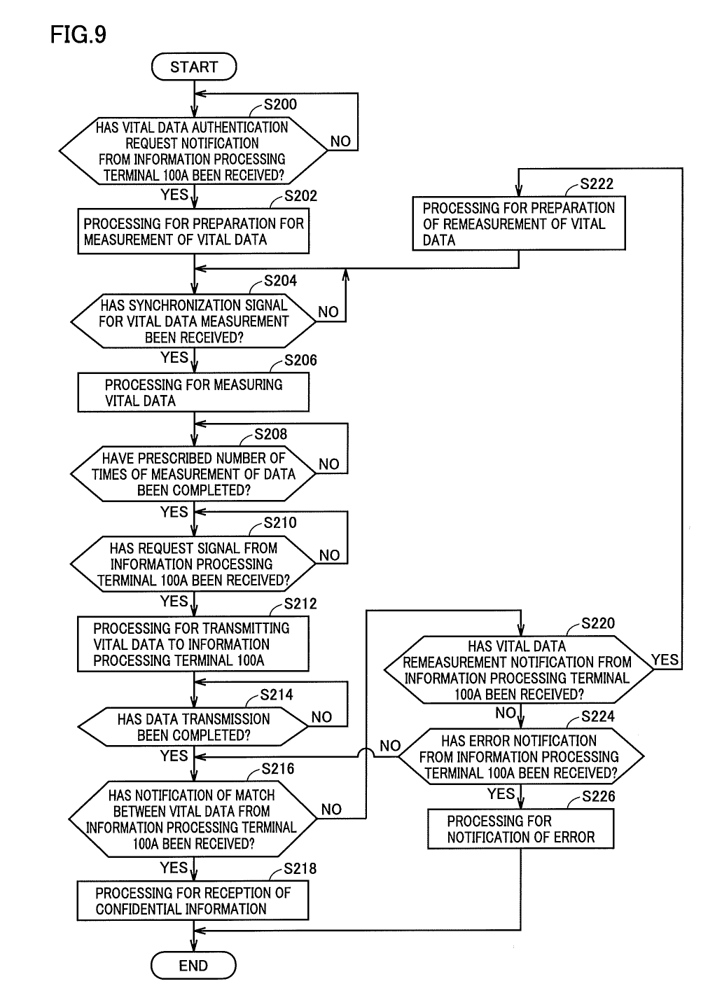

FIG. 9 is a flowchart illustrating control of communication of confidential information in information processing terminal 100B according to the first embodiment. Processing shown in FIG. 9 is performed by execution of a control program stored in storage device 140B by control device 170B. In another aspect, processing may be performed in part or in its entirety by a circuit element or other hardware.

In step S200, control device 170B determines whether or not it has received a vital data authentication request notification from information processing terminal 100A. When control device 170B determines that it has received the vital data authentication request notification from information processing terminal 100A (YES in step S200), the process proceeds to step S202. Otherwise (NO in step S200), control device 170B waits for reception of a vital data authentication request notification.

In step S202, control device 170B starts preparation for measurement of biological information (vital data) with biological sensor 120B.

In step S204, control device 170B determines whether or not it has received a synchronization signal from information processing terminal 100A. When control device 170B determines that it has received a synchronization signal from information processing terminal 100A (YES in step S204), the process proceeds to step S206. Otherwise (NO in step S204), control device 170B waits for reception of a synchronization signal.

In step S206, control device 170B has biological sensor 120B measure biological information (pulse waves) in response to the input synchronization signal. In step S208, control device 170B determines whether or not measurement by biological sensor 120B has been conducted a prescribed number of times defined in the synchronization signal. When control device 170B determines that a prescribed number of times of measurement have been completed (YES in step S208), the process proceeds to step S210. Otherwise (NO in step S208), control device 170B stands by until a prescribed number of times of measurement are completed.

In step S210, control device 170B determines whether or not it has received a request signal from information processing terminal 100A. When control device 170B determines that it has received a request signal from information processing terminal 100A (YES in step S210), the process proceeds to step S212. Otherwise (NO in step S210), control device 170B waits for reception of a request signal.

In step S212, control device 170B transmits a result of measurement by biological sensor 120B to information processing terminal 100A. In step S214, control device 170B determines whether or not transmission of the result of measurement to information processing terminal 100A has been completed. When control device 170B determines that transmission of the result of measurement has been completed (YES in step S214), the process proceeds to step S216. Otherwise (NO in step S214), control device 170B stands by until transmission of the result of measurement is completed.

In step S216, control device 170B determines whether or not it has received a vital data match notification indicating match between results of measurement by biological sensors 120A and 120B from information processing terminal 100A. When control device 170B determines that it has received the vital data match notification from information processing terminal 100A (YES in step S216), it performs reception processing for receiving confidential information from information processing terminal 100A (step S218). Otherwise (NO in step S216), the process proceeds to step S220.

In step S220, control device 170B determines whether or not it has received a request signal (a vital data remeasurement notification) requesting remeasurement by biological sensor 120B from information processing terminal 100A. When control device 170B determines that it has received the vital data remeasurement notification (YES in step S220), the process proceeds to step S222. Otherwise (NO in step S220), the process proceeds to step S224.

In step S222, control device 170B prepares for remeasurement of biological information by biological sensor 120B and waits for reception of a synchronization signal giving a notification of measurement timing.

In step S224, control device 170B determines whether or not it has received an error notification indicating unmatch between results of measurement by biological sensors 120A and 120B from information processing terminal 100A. When control device 170B determines that it has received an error notification from information processing terminal 100A (YES in step S224), the process proceeds to step S226. Otherwise (NO in step S224), the process returns to step S216.

In step S226, control device 170B has notification device 130B show an image giving a notification of failure in authentication of information processing terminal 100A.

(b6. Summary)

According to the above, a user should only measure biological information of the user himself/herself with a biological sensor mounted on each information processing terminal which communicates, in communication of confidential information. Therefore, the user does not have to memorize complicated authentication information (a password) nor to take notes of the authentication information. Consequently, information processing system 1 according to the embodiment is higher in security than the conventional system.

The information processing system according to the embodiment uses biological information of which copying and obtainment is very difficult for a malicious third party in communication of confidential information. Consequently, the information processing system according to the embodiment can suppress impersonation more than the conventional system.

### C. Second Embodiment

(c1. System Configuration)

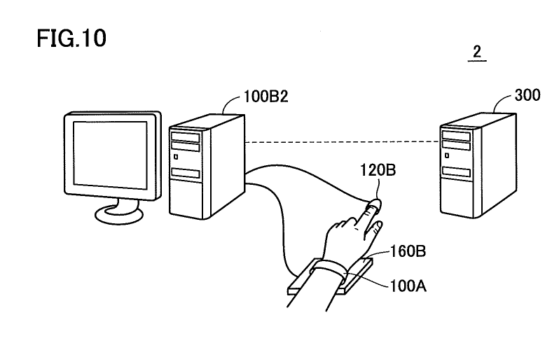

FIG. 10 is a diagram illustrating an exemplary configuration of an information processing system 2 according to a second embodiment. Information processing terminals 100A and 100B according to the first embodiment are both wearable terminals. In the example shown in FIG. 10, an information processing terminal 100B2 included in information processing system 2 according to the second embodiment is a stationary information processing terminal.

Referring to FIG. 10, information processing system 2 has information processing terminal 100A, information processing terminal 100B2, and a server 300 representing an external device. Information processing terminal 100B2 and server 300 are configured to be able to communicate with each other.

(c2. Configuration of Information Processing Terminal 100B2)

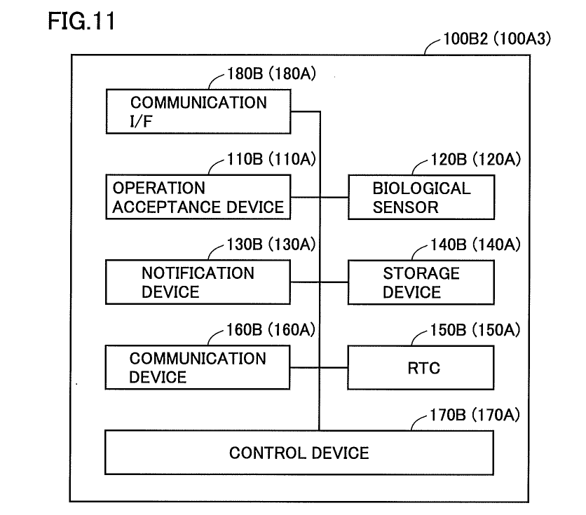

FIG. 11 is a block diagram illustrating an exemplary hardware configuration of information processing terminal 100B2 according to the second embodiment. Referring to FIG. 11, information processing terminal 100B2 is different from information processing terminal 100B described with reference to FIG. 2 in having a communication interface (I/F) 180B for communication with server 300. By way of example, communication interface 180B is a wireless local area network (LAN) interface. Information processing terminal 100B2 communicates with server 300 connected to a LAN or a WAN through communication interface 180B.

In the second embodiment, by way of example, an interface in conformity with the NFC standard is mounted on communication devices 160A and 160B. A rate of communication between information processing terminal 100B2 and server 300 is higher than a rate of communication between information processing terminals 100A and 100B2.

(c3. Example in Which Comparison of Biological Information is Made)

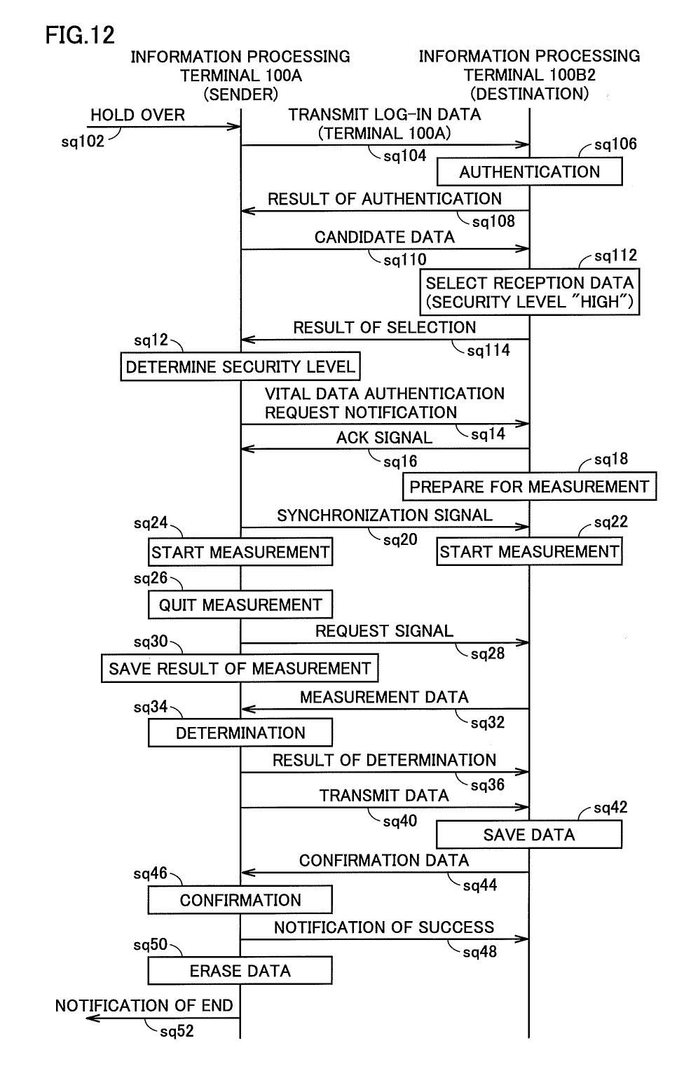

FIG. 12 is a sequence diagram illustrating control (No. 1) for transmission by information processing terminal 100A of confidential information to 100B2 according to the second embodiment. In the example shown in FIG. 12, a user transfers data “high” in security level, that is, highly confidential information, from information processing terminal 100A to information processing terminal 100B2. Since a portion the same as in FIG. 4 has the same reference numeral allotted, description thereof will not be repeated.

In sequence sq102, as shown in FIG. 10, a user who wears information processing terminal 100A holds communication device 160A of information processing terminal 100A over communication device 160B of information processing terminal 100B2. More specifically, the user sets a distance between communication devices 160A and 160B each incorporating the NFC interface to a prescribed distance (for example, 10 cm) or smaller. Thus, communication devices 160A and 160B can communicate with each other.

In sequence sq104, information processing terminal 100B2 receives first log-in data stored in storage device 140A of information processing terminal 100A through communication device 160B. The first log-in data includes, for example, an account name and a password.

In sequence sq106, whether or not the received first log-in data matches with log-in data stored in storage device 140B is determined.

In sequence sq108, information processing terminal 100B2 returns a result of authentication to information processing terminal 100A. In the example shown in FIG. 12, information processing terminal 100B2 notifies information processing terminal 100A of success of authentication based on the first log-in data.

In sequence sq110, information processing terminal 100A transmits candidates for transmission data to information processing terminal 100B2 in response to reception of a notification of success of authentication.

In sequence sq112, information processing terminal 100B2 shows on notification device 130B, the candidates for transmission data received from information processing terminal 100A and accepts selection by a user. The user selects data to be transferred from information processing terminal 100A to information processing terminal 100B2 based on contents shown on notification device 130B. In the example shown in FIG. 12, the user selects highly confidential information.

In sequence sq114, information processing terminal 100B2 transmits a result of selection by the user to information processing terminal 100A. In sequence sq12, information processing terminal 100A determines a security level of the data selected by the user and determines that the data is highly confidential information.

According to the above, confidential information can be communicated also between a wearable terminal and a stationary information processing terminal (for example, a personal computer) while impersonation by a third party is suppressed.

In another aspect, sequences sq110 to 114 do not have to be performed. Information processing terminal 100A may be configured to transmit predetermined information stored in storage device 140A to information processing terminal 100B2 after a series of comparison and determination processes based on biological information in response to reception of a notification of success of authentication from information processing terminal 100B2.

(c4. Example in Which Comparison of Biological Information Is Not Made (No. 1))

Selection of highly confidential information by a user is described in the example shown in FIG. 12. Control in an example in which a user selects less confidential information will be described below.

Information processing terminal 100A determines in sequence sq12 that data selected by a user is less confidential information. Thus, information processing terminal 100A transmits to information processing terminal 100B2 a notification of transmission of less confidential information selected by the user instead of a series of comparison and determination processes based on biological information (sequence sq14 to sequence sq36).

According to the above, information processing system 2 can quickly communicate less confidential information (confidential information of which leakage to the outside does not produce serious damage) without comparison and determination based on biological information. Load imposed on the user can also be mitigated.

Though information processing terminal 100B2 is configured to store less confidential information received from information processing terminal 100A in storage device 140B in the example above, limitation thereto is not intended. In another aspect, information processing terminal 100B2 may be configured to transfer less confidential information received from information processing terminal 100A to server 300 through communication interface 180B. Information processing terminal 100B2 saves information on an area of storage of less confidential information in server 300, information on connection to server 300, and authentication information used for logging in server 300 (second log-in data) in storage device 140B in association with metadata of transmitted less confidential information (for example, a file name). According to such a configuration, information processing terminal 100B2 can have server 300 greater in storage capacity than information processing terminal 100B2 manage less confidential information of which leakage to the outside does not cause serious influence.

Though information processing terminal 100A is configured to transmit less confidential information as it is to information processing terminal 100B2 in the example above, limitation thereto is not intended. Information processing terminal 100A may be configured to encrypt less confidential information and transmit the encrypted less confidential information to information processing terminal 100B2. By way of example, information processing terminal 100A encrypts less confidential information with a prescribed result of measurement by biological sensor 120A. Examples of the prescribed result of measurement include a result of measurement by biological sensor 120A which is newly obtained each time an event of transmission of less confidential information occurs. Other examples of the prescribed result of measurement include a most recent result of measurement among results of measurement by biological sensor 120A stored in storage device 140A. In any case, the prescribed result of measurement is transmitted from information processing terminal 100A to information processing terminal 100B2. The prescribed result of measurement is communicated through short-range wireless communication between communication devices 160A and 160B. Impersonation and interception by a third party can thus be suppressed.

(c5. Example in Which Comparison of Biological Information Is Not Made (No. 2))

In the above (example in which comparison of biological information is not made (No. 1)), information processing terminal 100A and information processing terminal 100B2 communicate data in accordance with a communication method under the NFC standard. A rate of data transfer under NFC, however, is approximately from 100 to 400 kbits/s, and when a data of interest has a large size, it takes a long time to transfer the data. While data is transferred, information processing terminal 100A and information processing terminal 100B2 should be kept at a prescribed distance or smaller from each other, and therefore a user cannot move away from information processing terminal 100B2 while the user is carrying information processing terminal 100A.

In order to solve the problem, in another aspect, instead of transmission of less confidential information from information processing terminal 100A to information processing terminal 100B2, server 300 may transmit less confidential information to information processing terminal 100B2. This communication control will be described below.

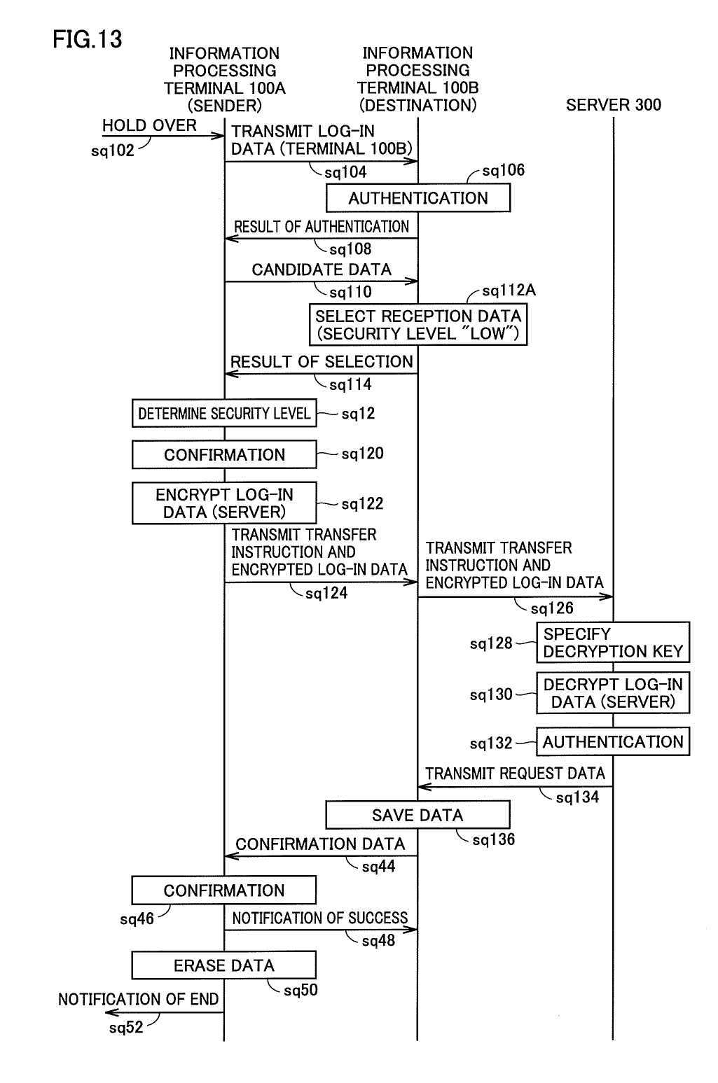

FIG. 13 is a sequence diagram illustrating control for transmission of less confidential information by information processing terminal 100A to 100B2 according to the second embodiment. Since a portion the same as in FIG. 12 has the same reference numeral allotted, description thereof will not be repeated.

In sequence sq112A, a user selects less confidential information. In response, in sequence sq12, information processing terminal 100A determines that the data to be transmitted to information processing terminal 100B2 is less confidential information.

In sequence sq120, information processing terminal 100A checks whether or not the data selected by the user is stored in server 300 configured to be able to communicate with information processing terminal 100B2. By way of example, information processing terminal 100A determines whether or not the data has been transmitted to server 300 based on tag/flag information (metadata) added to the data selected by the user. When information processing terminal 100A determines that the data was transmitted to server 300 in the past, it determines that the data is stored in server 300. In the example shown in FIG. 13, information processing terminal 100A determines that the data selected by the user is stored in server 300.

In sequence sq122, information processing terminal 100A encrypts second log-in data for accessing server 300. Second log-in data includes, for example, an account name and a password. By way of example, information processing terminal 100A encrypts the second log-in data with a prescribed result of measurement by biological sensor 120A stored in storage device 140A. Specifically, the prescribed result of measurement is a most recent result of measurement (of which time and day of measurement is the latest) among results of measurement by biological sensor 120A stored in storage device 140A. More specifically, information processing terminal 100A calculates peaks from the prescribed result of measurement (for example, the result of measurement shown in FIG. 7) and encrypts the second log-in data with values at three points high in value of the peaks. Server 300 also stores in advance the same encryption condition.

In sequence sq124, information processing terminal 100A transmits a transfer instruction for transferring the data selected by the user to information processing terminal 100B2 and the encrypted second log-in data to information processing terminal 100B2. In sequence sq126, information processing terminal 100B2 transfers such information received from information processing terminal 100A to server 300 through communication interface 180B.

In sequence sq128, server 300 specifies a decryption key for decrypting the encrypted second log-in data. By way of example, the user periodically transmits information including the result of measurement by biological sensor 120A from information processing terminal 100A to server 300 via information processing terminal 100B2. Under such conditions, server 300 calculates peaks from the most recent result of measurement among results of measurement by biological sensor 120A stored in the server itself and specifies values at three points high in value of the peaks as a decryption key.

In another aspect, information processing terminal 100A and server 300 may be configured to use a predetermined result of measurement among results of measurement by biological sensor 120A as an encryption key/a decryption key.

In yet another aspect, information processing terminal 100A may be configured to transmit metadata (for example, time and day of measurement) of a result of measurement by biological sensor 120A used for encryption together with the encrypted second log-in data. In such a case, server 300 specifies a result of measurement to be used for decryption of the second log-in data with the metadata.

In transmission of a result of measurement by biological sensor 120A to be used for encryption/decryption to information processing terminal 100B2, information processing terminal 100A desirably transmits the result under the standard of short range wireless communication of which coverage is relatively small (for example, from 1 meter to several centimeters), in order to suppress the possibility of interception of the encryption key/the decryption key by a malicious third party.

In sequence sq130, server 300 decrypts the encrypted second log-in data based on the specified decryption key.

In sequence sq132, server 300 determines whether or not the decrypted second log-in data matches with the log-in data stored in the server itself. In the example shown in FIG. 13, server 300 determines that the decrypted second log-in data matches with the log-in data stored in the server itself and authenticates information processing terminal 100B2.

In sequence sq134, server 300 transmits the data selected by the user (less confidential information) to authenticated information processing terminal 100B2.

In sequence sq136, information processing terminal 100B2 saves the data received from server 300 in storage device 140B.

Information processing system 2 according to the configuration can transfer less confidential information to an information processing terminal designated as a destination from server 300 in communication of less confidential information. Consequently, information processing system 2 can transfer less confidential information to the information processing terminal designated as the destination from server 300 at a communication rate higher than a communication rate between information processing terminals 100A and 100B.

The user who uses information processing system 2 can move away from information processing terminal 100B2 (communication device 160B) with information processing terminal 100A which does not communicate less confidential information being attached thereto, while information processing terminal 100B2 and server 300 are communicating less confidential information therebetween.

Information processing terminal 100A included in information processing system 2 encrypts second log-in data for accessing server 300 with biological information of which copying and obtainment is very difficult for a malicious third party. Therefore, information processing system 2 can suppress impersonation by a malicious third party even in communication of less confidential information.

### D. Third Embodiment

(d1. Overview)

Use of an unmanned aerial vehicle such as a drone has recently rapidly spread. Such an unmanned aerial vehicle generally operates in accordance with a predetermined program or by remotely been controlled by an external device.

When the external device is impersonated by a malicious third party, the unmanned aerial vehicle is controlled by the third party. For example, when an unmanned aerial vehicle is carrying cargo freights or when an unmanned aerial vehicle is used for the military purpose, people nearby are exposed to jeopardy.

A configuration and control for preventing impersonation of an external device which controls an unmanned aerial vehicle will be described below.

(d2. System Configuration)

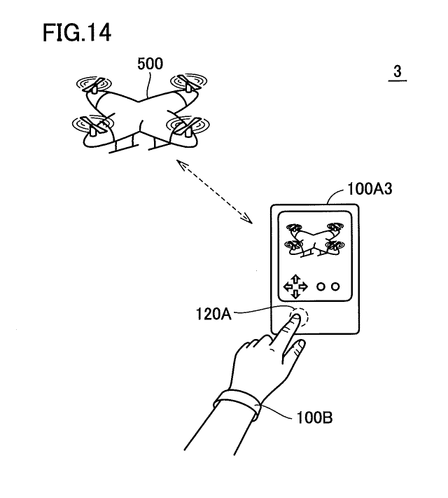

FIG. 14 is a diagram illustrating an exemplary configuration of an information processing system 3 according to a third embodiment. Information processing system 3 has an information processing terminal 100A3, information processing terminal 100B, and an unmanned aerial vehicle 500. By way of example, information processing terminal 100A3 is a tablet terminal. Since information processing terminal 100A3 is identical in hardware configuration to information processing terminal 100B2 shown in FIG. 11, description thereof will not be repeated.

Unmanned aerial vehicle 500 is a flying object which performs autonomous operations based on an external control command, and includes a multicopter and a drone by way of example. Information processing terminal 100A3 is a terminal for operating unmanned aerial vehicle 500 and an application for controlling operations of unmanned aerial vehicle 500 (hereinafter also referred to as a “control application”) is stored in storage device 140A.

(d3. Method of Controlling Unmanned Aerial Vehicle 500)

A user of information processing system 3 controls operations of unmanned aerial vehicle 500 by operating information processing terminal 100A3 while he/she wears information processing terminal 100B.

Initially, the user launches the control application by operating operation acceptance device 110A (for example, a touch panel). The control application has notification device 130A functioning as a display show an operation screen for operating unmanned aerial vehicle 500. The user operates operation acceptance device 110A in accordance with a representation on notification device 130A.

The control application verifies whether or not a control signal in accordance with contents input to operation acceptance device 110A results from impersonation before transmission of the control signal to unmanned aerial vehicle 500.

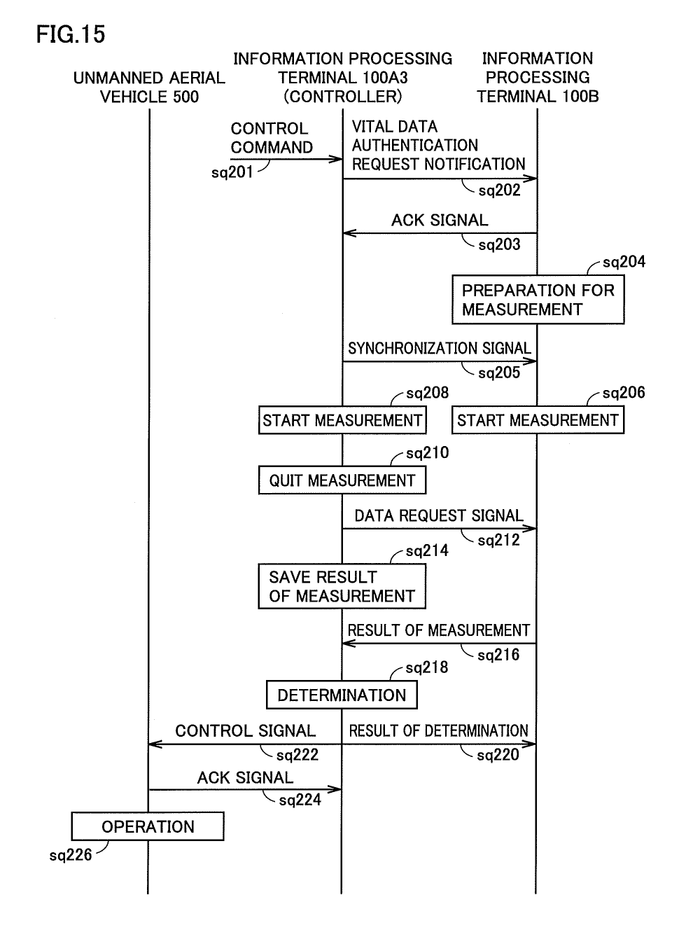

Specifically, the control application determines whether or not a result of measurement by biological sensor 120B satisfies a predetermined condition for a result of measurement by biological sensor 120A (for example, results of measurement from both biological sensors match with each other), and it allows transmission of the control signal to unmanned aerial vehicle 500 only when it determines that the condition is satisfied. Unmanned aerial vehicle 500 operates based on a control signal input from information processing terminal 100A3. Such control will be described below with reference to FIG. 15.

FIG. 15 is a sequence diagram illustrating control for transmitting a control signal to unmanned aerial vehicle 500 according to the third embodiment.

In sequence sq201, the user launches the control application by operating operation acceptance device 110A of information processing terminal 100A3 and inputs a control command to unmanned aerial vehicle 500.

In sequence sq202, information processing terminal 100A3 transmits a vital data authentication request notification to information processing terminal 100B upon receiving the input of the control command from the user.

In sequence sq203, information processing terminal 100B returns an ACK signal giving a notification of reception of the vital data authentication request notification to information processing terminal 100A3.

In sequence sq204, information processing terminal 100B starts preparation for measurement of biological information (pulse waves) with biological sensor 120B. In sequence sq205, information processing terminal 100A3 transmits a synchronization signal to information processing terminal 100B in response to reception of the ACK signal from information processing terminal 100B.

In sequence sq206, information processing terminal 100B starts measurement of pulse waves of the user in response to the synchronization signal input from information processing terminal 100A3. In sequence sq208, information processing terminal 100A3 also starts measurement of pulse waves of the user in response to the synchronization signal transmitted to information processing terminal 100B.

In sequence sq210, information processing terminal 100A3 quits measurement of the biological information. In sequence sq212, information processing terminal 100A3 transmits a request signal requesting transmission of the result of measurement by biological sensor 120B to information processing terminal 100B. In sequence sq214, information processing terminal 100A3 stores (saves) the result of measurement by biological sensor 120A in storage device 140A.

In sequence sq216, information processing terminal 100B transmits the result of measurement by biological sensor 120B to information processing terminal 100A3 in response to an input of the request signal from information processing terminal 100A3.

In sequence sq218, information processing terminal 100A3 determines whether or not the result of measurement by biological sensor 120A satisfies a predetermined condition for the result of measurement by biological sensor 120B. By way of example, information processing terminal 100A3 determines whether or not the results of measurement by biological sensors 120A and 120B match with each other. Determination is based on the condition shown in table Ta1. In the example shown in FIG. 15, information processing terminal 100A3 determines that the results of measurement by biological sensors 120A and 120B match with each other.

In sequence sq220, information processing terminal 100A3 transmits a result of determination indicating match between the results of measurement by biological sensors 120A and 120B to information processing terminal 100B. In sequence sq222, information processing terminal 100A3 transmits a control signal based on the control command from the user to unmanned aerial vehicle 500 through a communication interface 180A. Communication interface 180A is a wireless LAN interface by way of example.

In sequence sq224, unmanned aerial vehicle 500 returns to information processing terminal 100A3, an ACK signal giving a notification of reception of the control signal from information processing terminal 100A3. In sequence sq226, unmanned aerial vehicle 500 operates based on the input control signal.

According to the above, information processing terminal 100A3 according to the third embodiment can determine whether or not a control signal for operating unmanned aerial vehicle 500 has been input by an authorized user by using biological information of which copying and obtainment is very difficult. Therefore, information processing terminal 100A3 according to the third embodiment can suppress an operation of unmanned aerial vehicle 500 by an impersonating party.

Though information processing terminal 100A3 is configured to make comparison and determination based on biological information in response to an input of a control command in the example above, limitation thereto is not intended. In another aspect, information processing terminal 100A3 incorporates at least one of an acceleration sensor, a vibration sensor, and a sensor which senses holding of information processing terminal 100A3 by a user, which are not shown. Information processing terminal 100A3 may be configured to make comparison and determination based on biological information when such a sensor senses a prescribed operation by a user.

(d4. Control in Example in Which Results of Measurement Do Not Match)

An example in which results of measurement by biological sensors 120A and 120B do not match with each other is described with reference to FIG. 15. A control example in which these results of measurement do not match with each other will be described below.

When it is determined in sequence sq218 that results of measurement by biological sensors 120A and 120B do not match with each other, information processing terminal 100A3 determines that the control command has been input by an impersonating third party and transmits an error command to unmanned aerial vehicle 500.

In another aspect, information processing terminal 100A3 may be configured to remeasure biological information with biological sensors 120A and 120B and compare results of measurement up to a prescribed number of times (for example, three times) defined as the upper limit when it is determined that results of measurement by biological sensors 120A and 120B do not match with each other. According to such a configuration, information processing terminal 100A3 transmits an error command to unmanned aerial vehicle 500 when it determines a prescribed number of times that the results of measurement by biological sensors 120A and 120B do not match with each other.

Unmanned aerial vehicle 500 is controlled to perform a predetermined operation in response to reception of an error command. By way of example, unmanned aerial vehicle 500 slowly descends and makes a forced landing while it issues a warning to the surroundings by using sound or light in response to reception of the error command.

In another aspect, unmanned aerial vehicle 500 may gain altitude and self-destruct at prescribed timing (for example, timing when the altitude attains to 100 m) in response to reception of the error command.

In yet another aspect, unmanned aerial vehicle 500 may locate a wide space where there is no building in the surroundings such as sea and make a forced landing in response to reception of the error command. In this case, unmanned aerial vehicle 500 locates a wide space where there is no building in the surroundings with a camera or a global positioning system (GPS).

Unmanned aerial vehicle 500 can minimize influence on people and objects nearby by performing these predetermined operations in response to reception of the error command.

Though description has been given above with reference to an unmanned aerial vehicle by way of example, limitation thereto is not intended. Control for suppressing impersonation is applicable to a machine which performs an autonomous operation based on an external control command such as an unmanned vehicle, an unmanned marine vessel, or an exploratory satellite.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### Additional Aspect 1

An information processing terminal which communicates confidential information with a sensor terminal including a first biological sensor which measures biological information of a first type, the information processing terminal including:

a reception device which receives a result of measurement by the first biological sensor from the sensor terminal;

a second biological sensor which measures biological information of the first type; and

a control device configured to communicate the confidential information with the sensor terminal when the result of measurement by the first biological sensor satisfies a predetermined condition for a result of measurement by the second biological sensor.

### Additional Aspect 2

The information processing terminal described in additional aspect 1, in which the control device is configured to determine that the result of measurement by the first biological sensor satisfies the predetermined condition when a ratio of match between the results of measurement by the first and second biological sensors within a prescribed period is equal to or higher than a prescribed value.

### Additional Aspect 3

The information processing terminal described in additional aspect 1 or 2, the information processing terminal further including an operation acceptance device which accepts input of information, in which the control device is configured to transmit to the sensor terminal, a request signal requesting measurement of the biological information of the first type by the first biological sensor and transmission of the result of measurement of the biological information in response to input of predetermined information to the operation acceptance device.

### Additional Aspect 4

The information processing terminal described in additional aspect 3, in which the control device is configured to transmit again the request signal to the sensor terminal up to a prescribed number of times defined as the upper limit when it is determined that the result of measurement by the first biological sensor transmitted in response to transmission of the request signal does not satisfy the predetermined condition.

### Additional Aspect 5

The information processing terminal described in additional aspect 4, in which the control device is configured to calculate a first average value representing an average value of a plurality of results of measurement by the first biological sensor transmitted in response to transmission of the request signal, to calculate a second average value representing an average value of a plurality of results of measurement by the second biological sensor corresponding to the plurality of results of measurement by the first biological sensor, and to determine whether or not the result of measurement by the first biological sensor satisfies the predetermined condition by determining whether or not the first average value satisfies the predetermined condition for the second average value.

### Additional Aspect 6

The information processing terminal described in additional aspect 5, in which the control device is configured to correct a result of next measurement by the first biological sensor based on a difference between the first average value and the second average value and to determine whether or not the result of next measurement by the first biological sensor satisfies the predetermined condition when it is determined that the first average value does not satisfy the predetermined condition for the second average value.

### Additional Aspect 7

The information processing terminal described in any of additional aspects 1 to 6, in which the control device is configured to further transmit a synchronization signal designating timing of measurement by the first biological sensor to the sensor terminal, and the second biological sensor is configured to measure the biological information of the first type at timing in accordance with the synchronization signal.

### Additional Aspect 8

The information processing terminal described in any of additional aspects 1 to 7, in which the control device is configured to give an error notification when it is determined that the result of measurement by the first biological sensor does not satisfy the predetermined condition.

### Additional Aspect 9

The information processing terminal described in any of additional aspects 1 to 8, in which the control device is configured to verify whether or not transmission of the confidential information to the sensor terminal has been successful by comparing the confidential information transmitted to the sensor terminal with at least a part of the confidential information returned from the sensor terminal.

### Additional Aspect 10

The information processing terminal described in additional aspect 9, the information processing terminal further including a storage device which stores the confidential information to be transmitted to the sensor terminal, in which the control device is configured to erase from the storage device, the confidential information transmitted to the sensor terminal when success of transmission of the confidential information to the sensor terminal has been verified.

Though embodiments of the present invention have been described, it should be understood that the embodiments disclosed herein are illustrative and non-restrictive in every respect. The scope of the present invention is defined by the terms of the claims and is intended to include any modifications within the scope and meaning equivalent to the terms of the claims.

What is claimed is:

1. An information processing terminal which communicates confidential information with a sensor terminal including a first biological sensor which measures biological information of a first type, the information processing terminal comprising:
a reception device which receives a result of measurement by the first biological sensor from the sensor terminal;
a second biological sensor which measures biological information of the first type; and
a control device configured to communicate the confidential information with the sensor terminal when the result of measurement by the first biological sensor satisfies a predetermined condition for a result of measurement by the second biological sensor.

2. The information processing terminal according to claim 1, wherein
the control device is configured to be able to switch between a first mode in which the confidential information is communicated with the sensor terminal when the result of measurement by the first biological sensor satisfies the predetermined condition and a second mode in which the confidential information is communicated with the sensor terminal without comparison between the result of measurement by the first biological sensor and the result of measurement by the second biological sensor, and
communicates the confidential information with the sensor terminal in the first mode when a security level of the confidential information to be communicated with the sensor terminal is equal to or higher than a predetermined level.

3. The information processing terminal according to claim 2, the information processing terminal further comprising a storage device which stores the result of measurement by the second biological sensor, wherein
the control device encrypts the confidential information with a prescribed result of measurement stored in the storage device and transmits the encrypted confidential information to the sensor terminal in the second mode when the security level of the confidential information to be transmitted to the sensor terminal is lower than the predetermined level.

4. The information processing terminal according to claim 2, wherein
the control device communicates the confidential information with the sensor terminal through short-range wireless communication when the security level of the confidential information to be communicated with the sensor terminal is equal to or higher than the predetermined level.

5. The information processing terminal according to claim 4, wherein
the control device communicates the confidential information with the sensor terminal through wireless communication higher in bit rate than the short-range wireless communication when the security level of the confidential information to be communicated with the sensor terminal is lower than the predetermined level.

6. The information processing terminal according to claim 4, wherein
the control device verifies whether the confidential information is present in an external device configured to be able to communicate with the sensor terminal when the security level of the confidential information to be transmitted to the sensor terminal is lower than the predetermined level, and
transmits a control signal having the external device transfer the confidential information to the sensor terminal to any one of the external device and the sensor terminal when presence of the confidential information in the external device is verified.

7. The information processing terminal according to claim 2, the information processing terminal being configured to be able to communicate with an external device, wherein
the control device is configured to
receive the security level of the confidential information from the sensor terminal in receiving the confidential information from the sensor terminal, and
transfer the confidential information received from the sensor terminal to the external device when the security level of the confidential information is lower than the predetermined level.

8. The information processing terminal according to claim 7, the information processing terminal further comprising a storage device, wherein
the control device is configured to have the storage device store prescribed information when the confidential information received from the sensor terminal is transferred to the external device, and
the prescribed information includes at least any one of information on connection to the external device, information on an area of storage of the confidential information in the external device, and information used for logging in the external device.

9. The information processing terminal according to claim 2, wherein
the control device includes at least one of a component which transmits information on the security level of the confidential information to be transmitted to the sensor terminal to the sensor terminal and a component which requests from the sensor terminal, information on the security level of the confidential information received from the sensor terminal.

10. The information processing terminal according to claim 2, the information processing terminal further comprising an operation acceptance device which accepts input of information, wherein
the control device sets the security level of the confidential information to be communicated with the sensor terminal based on information input to the operation acceptance device.

11. The information processing terminal according to claim 2, the information processing terminal further comprising an operation acceptance device which accepts input of information, wherein
the control device determines the security level of the confidential information to be communicated with the sensor terminal based on any one of information on a storage area where the confidential information is stored, first security information added to the confidential information, and second security information input to the operation acceptance device in communication of the confidential information with the sensor terminal.

12. The information processing terminal according to claim 1, wherein
the control device includes at least one of a component which encrypts the confidential information to be transmitted to the sensor terminal with a prescribed result of measurement by the second biological sensor and a component which decrypts the confidential information received from the sensor terminal based on the prescribed result of measurement.

13. The information processing terminal according to claim 12, the information processing terminal further comprising a storage device which stores the result of measurement by the second biological sensor, wherein
the prescribed result of measurement includes any one of the result of measurement by the second biological sensor obtained each time the confidential information is communicated with the sensor terminal and a most recent result of measurement among the results of measurement by the second biological sensor stored in the storage device.

14. The information processing terminal according to claim 12, wherein
the control device transmits the prescribed result of measurement to the sensor terminal through short-range wireless communication.

15. An information processing terminal which transmits a control signal to an external device, the information processing terminal comprising:
a reception device which receives information from a sensor terminal, the sensor terminal including a first biological sensor which measures biological information of a first type, the reception device being configured to receive a result of measurement by the first biological sensor from the sensor terminal;
a second biological sensor which measures biological information of the first type; and
a control device which transmits the control signal to the external device when the result of measurement by the first biological sensor satisfies a predetermined condition for a result of measurement by the second biological sensor.

16. A non-transitory computer readable recording medium having a program for transmitting a control signal to an external device stored thereon, the program causing the computer to perform:
receiving a result of measurement of biological information of a first type from a sensor terminal;
obtaining the result of measurement of the biological information of the first type by a biological sensor connected to the computer;
determining whether a result of measurement by the biological sensor satisfies a predetermined condition for the result of measurement received from the sensor terminal; and
transmitting the control signal to the external device when it is determined that the predetermined condition is satisfied.

17. An information processing system comprising:
a sensor terminal including a first biological sensor which measures biological information of a first type; and
the information processing terminal according to claim 1.

18. A control method for an information processing terminal including a biological sensor which measures biological information of a first type to communicate confidential information with a sensor terminal which measures biological information of the first type, the control method comprising:
receiving a result of measurement of the biological information of the first type from the sensor terminal;
measuring biological information of the first type;
determining whether the result of measurement received from the sensor terminal satisfies a predetermined condition for a result of measurement of the biological information in the measuring the biological information; and
communicating confidential information with the sensor terminal when it is determined that the predetermined condition is satisfied.

19. A non-transitory computer readable recording medium having a program stored thereon, the program for causing the computer to perform the method according to claim 18.
